(19) United States
(12) Patent Application Publication
(10) Pub. No.: US 2006/0280542 A1
(43) Pub. Date: Dec. 14, 2006

(54) Flatbed printing machine

(75) Inventors: Michael Reichenbach, Waldkirch (DE); Dietmar Weber, Reute (DE)

Correspondence Address: CROWELL & MORING LLP;INTELLECTUAL PROPERTY GROUP, P.O. BOX 14300, WASHINGTON, DC, 20044-4300, US

(73) Assignee: THIEME GmbH & Co. KG, Teningen (DE)

(21) Appl. No.: 11/440,024

(22) Filed: May 25, 2006

Related U.S. Application Data
(60) Provisional application No. 60/685,022, filed on May 27, 2005.

(30) Foreign Application Priority Data
May 25, 2005 (DE) 20 2005 008 786.6

(51) Int. Cl. B41J 13/26

(52) U.S. Cl. 400/630

(57) ABSTRACT

A flatbed printing machine includes at least one adjustable side stop in an infeed area for the medium to be printed. The side stop is arranged between an infeed area edge and a feeder edge over which the medium to be printed is carried. The side stop is adjustable in a guide parallel to the infeed area edge and to the feeder edge. A link belt is provided, which link belt is capable of tracking the side stop and covering a gap that would otherwise occur between the infeed area edge and the feeder edge.

### CROSS REFERENCE TO RELATED APPLICATIONS

This application claims the benefit of priority under 35 U.S.C. § 119(e) to U.S. Provisional Application No. 60/685,022, filed May 27, 2005, and claims the benefit of priority under 35 U.S.C. § 119(a) to German Application No. 20 2005 008 786.6, filed May 25, 2005, the entire disclosures of these applications are herein expressly incorporated by reference.

This application is also related to U.S. Application No. ______, entitled “Printing Table for Flatbed Printers”; U.S. Application No. ______,entitled “Printing Table for a Flatbed Printing Machine”; and U.S. Application No. ______, entitled “Flatbed Printing Machine”, filed on even date herewith.

### BACKGROUND AND SUMMARY OF THE INVENTION

The invention relates to a flatbed printing machine with at least one adjustable side stop in the infeed area for the medium to be printed. The side stop is arranged between the edge of the infeed area and a feeder edge across which the medium to be printed is carried and is adjustable in a guide parallel to the infeed area edge and to the feeder edge.

Adjustable page stops are needed in known flatbed printing machines in order to align a medium to be printed during the feed process. In order to arrange the side stop so as to be displaceable, it must be adjustable in a guide. Since the side stop on one side is arranged flush with the infeed area edge, and on the other is flush with a feeder edge, an open area arises during the displacement of the page stop between the infeed area edge and the feeder edge across which the medium to be printed must travel. In order to avoid the medium to be printed from sagging and possibly being soiled, after an adjustment of the side stop in known flatbed printing machines, this gap between the infeed area edge and the feeder edge is filled through insertion of metal plates. Upon each adjustment of the side stop, appropriate metal plates thus must be inserted in order to almost completely close the gap. Such side stops are also designated as front registers.

With the invention, a flatbed printing machine of simplified operation is to be created.

According to the invention, a flatbed printing machine is provided for this purpose with at least one adjustable side stop in the infeed area for the medium to be printed. The side stop is arranged between an infeed area edge and a feeder edge over which the medium to be printed is carried and is adjustable in a guide parallel to the infeed area edge. A link belt is provided, the link belt being capable of tracking the side stop and covering a gap between the infeed area edge and the feeder edge.

Through provision of a link belt that is capable of tracking the side stop, the gap between the infeed area edge and the feeder edge can essentially be fully covered even at various settings of the side stop, without the need for cover elements that have to be inserted manually. The link belt simply tracks the side stop and as a result covers a gap between the infeed area edge and the feeder edge that arose as a result of displacement of the side stop. The link belt advantageously is introduced at a point in the gap which lies in the area of an end position for the smallest format that can be handled. If then larger formats are processed, the link belt can simply track the side stop and the area across which the medium to be printed passes between the infeed area edge and the feeder edge can be essentially fully covered independent of its format.

In a further development of the invention, the link belt covers the gap flush with the infeed area edge and the feeder edge.

In this manner, an essentially level surface is created between infeed area edge and feeder edge so that the medium to be printed does not have to be carried over edges or steps.

In a further development of the invention, the link belt is connected to the side stop.

In this manner, the link belt can track the side stop in a particularly simple manner since upon a shifting of the side stop, it is automatically drawn after it or is pushed back again.

In a further development of the invention, the link belt is channeled between the infeed area edge and the feeder edge.

As a result, a sagging of the link belt is avoided when even relatively long gaps must be covered in the case of relatively long shifts of the side stop. Alternatively, channeling of the link belt can be omitted if the latter is tensioned between the side stop, a deflection roller and a tensioning apparatus.

In a further development of the invention, the link belt is introduced from an area below the infeed area edge and the feeder edge.

Below the infeed area edge and the feeder edge, and thus also below the side stop, as a rule sufficient space is available to accommodate even relatively long lengths of the link belt and, if appropriate, to arrange a pretensioning device.

In a further development of the invention, the link belt has metal strips connected by means of articulation elements.

In a further development of the invention, two displaceable side stops, which can be displaced in opposite directions from a center of the infeed area are provided, behind each of which a link belt can track.

In this manner, the center of the medium to be printed can be arranged, independent of its format, always in the center of the printing machine. The link belts are advantageously guided out between the ends of the guide tracks opposite each other for the two side stops and into an area beneath the infeed area edge and the feeder edge. As a result, in the center of the infeed area an open area of the gap is unavoidably created which can then be covered by a fixed cover plate. To the right and the left of the cover plate, the link belts are then guided by deflector rollers to the height of the infeed area edge and of the feeder edge, so that in the entire area between the two side stops there is essentially no gap in which the medium to be printed could sag.

In a further development of the invention, a servo drive is assigned to each side stop and the link belts are each connected to the assigned side stop.

In this manner, each link belt can be simply hung onto an assigned side stop and when it is displaced, is pulled behind. In the case of appropriate dimensioning of the servo drive, the link belt can be drawn out against a pretension effect. This makes moving the link belt back considerably easier.

In a further development of the invention, at least one drum is provided for coiling up and feeding out the link belt.

In this manner, even large lengths of link belt can be accommodated in a space-saving manner. A drum shaft can be pretensioned by use of a spring so the link belt is drawn out in the event of a movement of the side stop and can also be drawn back into the drum. The drums advantageously are arranged in an area below the infeed area edge and the feeder edge.

Further features and advantages of the invention are found in the claims and the following description of a preferred embodiment of the invention in connection with the drawings.

### BRIEF DESCRIPTION OF THE DRAWINGS

FIG. 1 a perspective view of the infeed area of a flatbed printing machine according to the invention;

FIG. 2 shows the detail II in FIG. 1 in an enlarged depiction,

FIG. 3 shows the infeed area of FIG. 1 in another position of the side stops;

FIG. 4 shows the detail IV of FIG. 3 in an enlarged depiction;

FIG. 5 is a view of the adjusting mechanism for the side stops of the flatbed printing machine of FIG. 1; and

FIG. 6 is an enlarged depiction of the detail VI of FIG. 5.

### DETAILED DESCRIPTION OF THE DRAWINGS

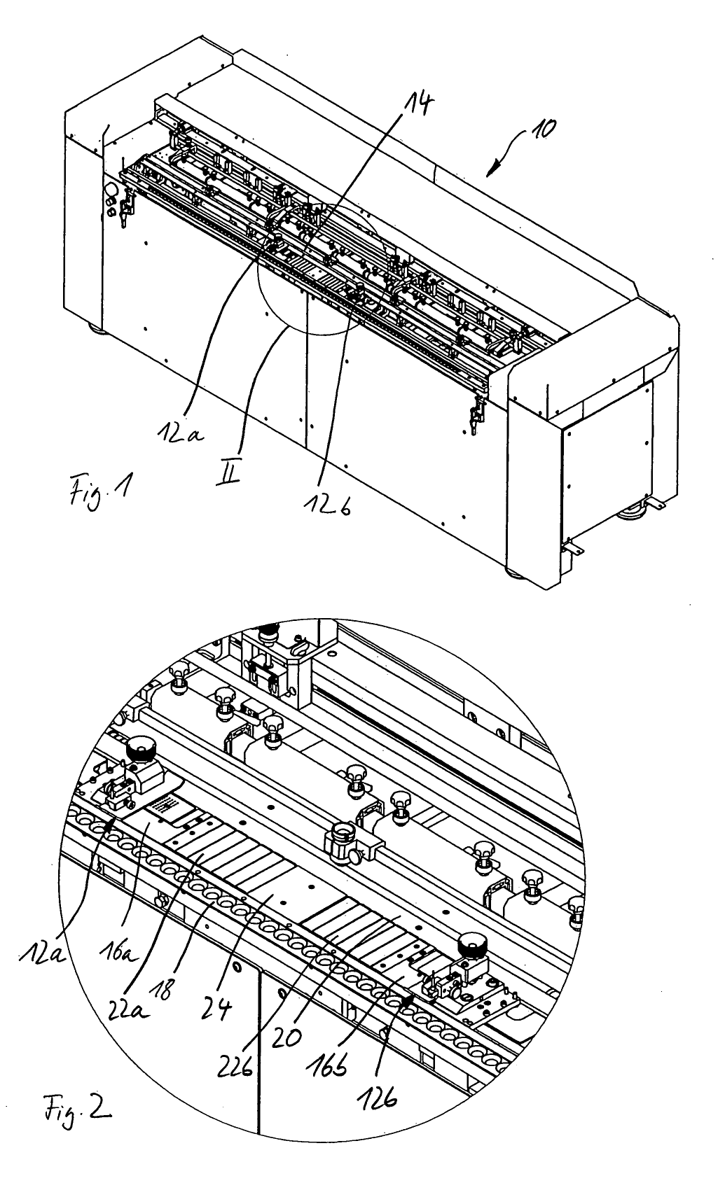

Depicted in FIG. 1 is an infeed area 10 of a flatbed printing machine not further depicted. In infeed area 10, a paper sheet to be printed is introduced, aligned by means of two side stops 12a, 12b and is brought into the grasping range of a gripper arrangement 14. After gripper arrangement 14 then has grasped the leading edge of the sheet of paper, it pulls the sheet of paper into the flatbed printing machine and arranges it in the printing position.

As can be discerned in FIG. 1, and more clearly in the enlarged depiction of FIG. 2, each of the two side stops 12a, 12b are provided with a support plate 16a, 16b, with support plates 16a, 16b being arranged between an infeed area edge 18 and a feeder edge 20 and are flush with them. In the area of support plates 16a, 16b, a gap is thus enclosed between infeed area edge 18 and feeder edge 20. In the area between the two side stops 12a, 12b, and specifically between the two support plates 16a, 16b, the gap is likewise enclosed by two link belts 22a, 22b and a center plate 24 so that essentially a continuous and flush surface results between infeed area edge 18 and feeder edge 20. Link belts 22a, 22b are each joined to the associated side stop 12a, 12b, and specifically to the respective support plates 16a, 16b. Upon a shifting of side stops 12a, 12b from the position depicted in FIG. 1 and FIG. 2 in an outward direction, link belts 22a, 22b would thus be drawn after them. Thus, independent of the position of side stops 12a, 12b, the link belts 22a, 22b would always cover the gap between infeed area edge 18 and feeder edge 20 in a flush manner.

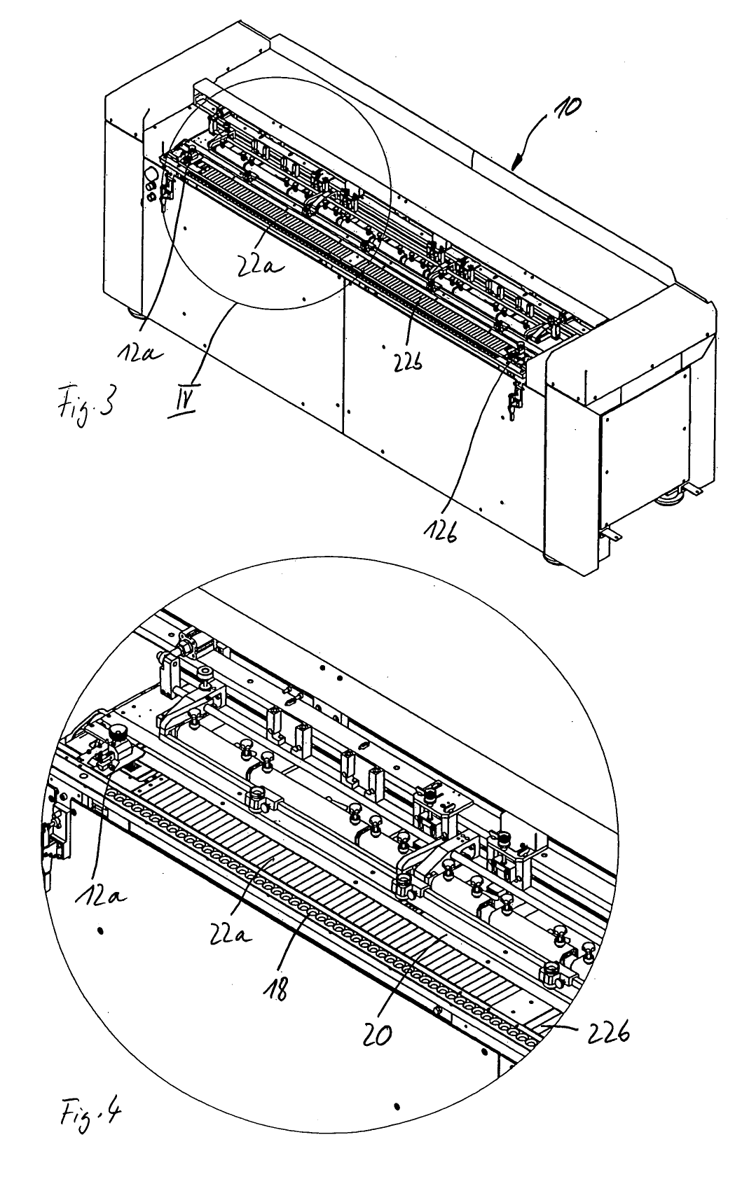

A shifted position of side stops 12a, 12b is depicted in the view of FIG. 3. The position of FIG. 3 shows an end position of side stops 12a, 12b and thus defines the maximum sheet format to be processed through the infeed area 10. As can be seen in FIG. 3 and FIG. 4, link belts 22a, 22b, upon shifting of side stops 12a, 12b in an outward direction, are drawn behind them in a simple manner. Upon movement of side stops 12a, 12b toward each other, link belts 22a, 22b then are pushed back and are arranged, in a manner yet to be explained, below infeed area edge 18 and feeder edge 20. In this process, link belts 22a, 22b are guided latterly to infeed area edge 18 and feeder edge 20. For this purpose, both infeed area edge 18 as well as feeder edge 20 are provided with a groove on their sides facing link belts 22a and 22b, respectively, in which the matching projections of link belts 22a, 22b are guided.

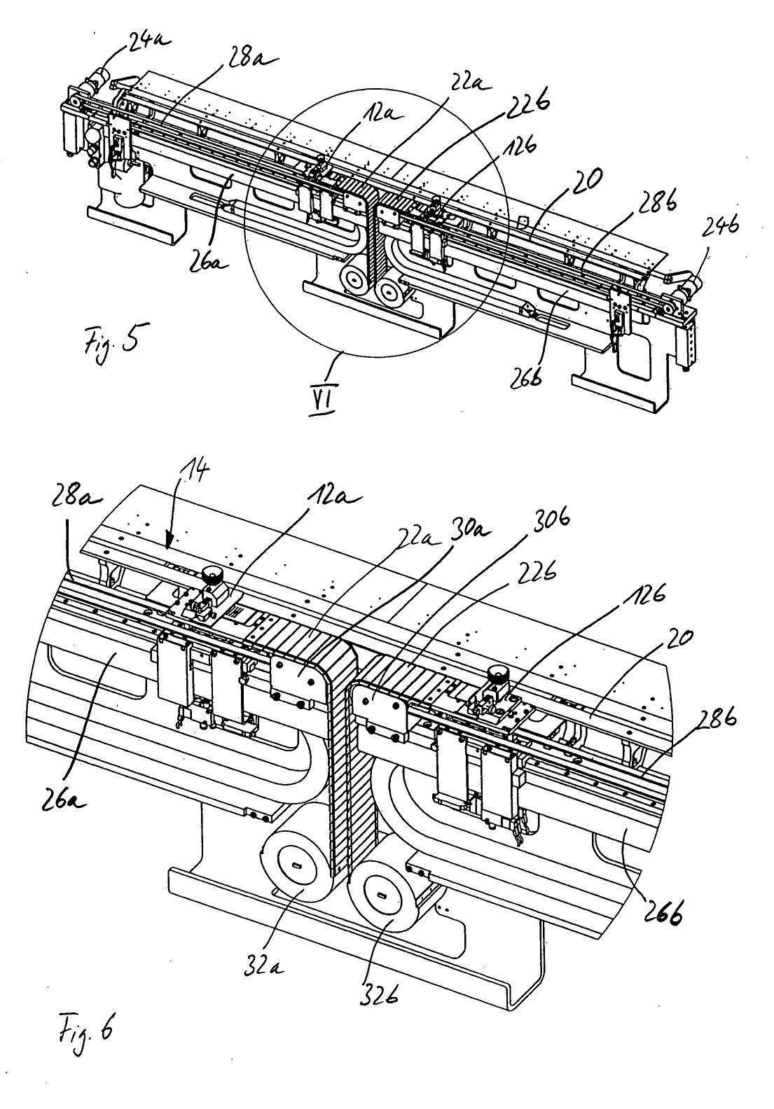

FIG. 5 shows the shifting mechanism for side stops 12a, 12b as well as the arrangement for drawing out or drawing in link belts 22a, 22b.

Each side stop 12a, 12b can be shifted parallel to feeder edge 20 and to infeed area edge, not depicted in FIG. 5, by way of a servo drive 24a, 24b assigned to each. For this purpose, side stops 12a, 12b each are borne on a corresponding guide rail 26a, 26b so as to be capable of being shifted, and are joined to a toothed belt 28a or a toothed belt 28b, whereby toothed belts 28a, 28b are guided on the one side across a drive wheel of the associated actuating servo drive 24a, 24b as well as across a deflection roller for each, which cannot be seen in FIG. 5, in a deflection block 30a, 30b for each.

As can be seen in FIG. 5 and FIG. 6, there is a gap between the ends of guide rails 26a, 26b facing each other, through which the two link belts 22a, 22b are guided downward into an area situated below the adjusting level of side stops 12a, 12b. In the area of deflection, link belts 22a, 22b, respectively, are guided across the deflection block 30a, 30b. Each link belt 22a, 22b thus is guided through between guide rails 26a, 26b and is directed onto a drum 32a or a drum 32b, respectively. Drums 32a, 32b provide a protected, space-saving accommodation of the areas of link belts 22a, 22b which are not needed for the current setting of side stops 12a, 12b. The drum shafts of drums 32a, 32b are advantageously pretensioned by way of a spring so that link belts 22a, 22b can be drawn off only against the force of the respective spring of the drums 32a, 32b, and vice versa are drawn back into drums 32a, 32b again through the effect of the respective springs. As a result, it is also ensured that link belts 22a, 22b are under preliminary tension in the area aligned flush to the infeed area edge and the feeder edge 20 in which they are to cover the gap. As a result and through the lateral guidance of the metal strips of link belts 22a, 22b in channels of feeder edge 20 and of the infeed area edge, it is ensured that link belts 22a, 22b cover the gap flush with the infeed area edge and with feeder edge 20. In the depiction of FIG. 5 and 6, center plate 24, which can be seen in FIG. 2, is not shown.

Guide rails 26a, 26b for side stops 12a, 12b are arranged beneath the infeed area edge and feeder edge 20 and thus below the surface over which the medium to be printed is carried. Below this surface, sufficient space is available to arrange even stably configured guide rails 26a, 26b as well as associated guide carriages for guiding side stops 12a, 12b.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A flatbed printing machine, comprising:
at least one adjustable side stop arranged in an infeed area for a medium to be printed with the printing machine, the side stop being arranged between an infeed area edge and a feeder edge across which the medium to be printed is carried, and the side stop being movable in a guide parallel to the infeed area edge and to the feeder edge; and
a link belt, which is capable of tracking the side stop, operatively configured to cover a gap between the infeed area edge and the feeder edge.

2. The flatbed printing machine according to claim 1, wherein the link belt covers the gap flush with the infeed area edge and with the feeder edge.

3. The flatbed printing machine according to claim 1, wherein the link belt is joined to the side stop.

4. The flatbed printing machine according to claim 2, wherein the link belt is joined to the side stop.

5. The flatbed printing machine according to claim 1, wherein the link belt is guided between the infeed area edge and the feeder edge.

6. The flatbed printing machine according to claim 2, wherein the link belt is guided between the infeed area edge and the feeder edge.

7. The flatbed printing machine according to claim 1, wherein the link belt is guided out of an area beneath the infeed area edge and the feeder edge.

8. The flatbed printing machine according to claim 2, wherein the link belt is guided out of an area beneath the infeed area edge and the feeder edge.

9. The flatbed printing machine according to claim 5, wherein the link belt is guided out of an area beneath the infeed area edge and the feeder edge.

10. The flatbed printing machine according to claim 1, wherein the link belt is formed by metal strips joined by articulation elements.

11. The flatbed printing machine according to claim 1, wherein two side stops are provided, the two side stops being adjustable in opposite directions out from a middle of the infeed area, each of the two side stops being tracked by a respective link belt.

12. The flatbed printing machine according to claim 2, wherein two side stops are provided, the two side stops being adjustable in opposite directions out from a middle of the infeed area, each of the two side stops being tracked by a respective link belt.

13. The flatbed printing machine according to claim 5, wherein two side stops are provided, the two side stops being adjustable in opposite directions out from a middle of the infeed area, each of the two side stops being tracked by a respective link belt.

14. The flatbed printing machine according to claim 11, further comprising a respective servo drive assigned to each side stop, and wherein each respective link belt is joined to the associated one of the side stops.

15. The flatbed printing machine according to claim 1, further comprising a drum for coiling and feeding out the link belt.

16. The flatbed printing machine according to claim 11, further comprising two drums, each of the two drums being provided for coiling and feeding out the respective link belt associated with the respective side stop.

17. The flatbed printing machine according to claim 14, further comprising two drums, each of the two drums being provided for coiling and feeding out the respective link belt associated with the respective side stop.
